(19) United States
(12) Patent Application Publication
(10) Pub. No.: US 2009/0322558 A1
(43) Pub. Date: Dec. 31, 2009

(54) Automatic Alert Playback Upon Recognition of a Paired Peripheral Device

(75) Inventors: Matt C. Videtich, Farmington Hills, MI (US); Steven C. Tengler, Grosse Point Park, MI (US)

Correspondence Address: Leydig, Voit & Mayer, Ltd., Two Prudential Plaza, Suite 4900, 180 North Stetson Avenue, Chicago, IL, 60601-6731, US

(73) Assignee: General Motors Corporation, Detroit, MI (US)

(21) Appl. No.: 12/165,236

(22) Filed: Jun. 30, 2008

(51) Int. Cl. H04Q 9/00; H04B 5/00

(52) U.S. Cl. 340/870.07; 455/41.1

(57) ABSTRACT

A system for providing alert information to a user of a vehicle comprising a telematics unit associated with the vehicle and further including a short range wireless interface. A mobile wireless device is paired with the vehicle via a pairing with the telematics unit. The mobile device further comprises a first communication interface for wirelessly receiving the alert information and a second communication interface for communicating with the telematics unit via the short range wireless interface. A processor controls the mobile device, running an application for detecting that the mobile device is within range of the telematics unit and for causing the alert information to be played in response to detecting that the mobile device is within range of the telematics unit.

### FIELD OF THE INVENTION

This invention relates generally to personal alert technology and more particularly to a system for providing an alert to a user of a vehicle.

### BACKGROUND OF THE INVENTION

Telematics systems in cars and other vehicles serve a number of functions that improve operator convenience and safety. For example, telematics units can place emergency calls, give driving directions, and so forth. One of the most useful safety features of many telematics units is the ability to provide vehicle users with alerts pertaining to important news or events, or pertaining to health and safety. For example, a telematics unit may provide a severe weather alert or a traffic condition alert to the user.

Frequently, such alerts may be issued from an issuing entity such as a control center at random times, and so alert information may be broadcast at a time when the vehicle and the associated telematics unit are not in an on state. As such, the telematics unit will have to retrieve all such alerts when it is activated, typically at a “key-on” event defined as the time that the user turns the vehicle ignition on. At this time, the telematics unit retrieves the past alerts through an SMS message to establish a packet session followed by the transmission and download of a .wav file. These activities utilize a relatively high cost channel, and as such incur substantial costs for the provider and/or the user. Once the alerts have been retrieved, they are generally played in order of importance, such that an urgent message is played immediately, a medium priority message is played after any urgent messages, and low priority messages are played later or are not even downloaded at this time.

While the providing of alerts to the users of telematics units is an important function, the manner in which such alerts are presently transferred is less than ideal in terms of cost as well as other parameters.

### BRIEF SUMMARY OF THE INVENTION

Examples of the invention include a system for providing alert information to a user of a vehicle, the system comprising a telematics unit associated with the vehicle and further including a short range wireless interface. A mobile wireless device is paired with the vehicle via a pairing with the telematics unit. The mobile device further comprises a first communication interface for wirelessly receiving the alert information and a second communication interface for communicating with the telematics unit via the short range wireless interface. A processor controls the mobile device, running an application for detecting that the mobile device is within range of the telematics unit and for causing the alert information to be played in response to detecting that the mobile device is within range of the telematics unit.

In another example, the invention includes a computer-readable medium having thereon computer-executable instructions for providing alert information to a user of a vehicle. The computer-executable instructions include instructions for pairing a mobile device to a telematics unit associated with the vehicle, and instructions for receiving alert information over a second communication interface of the mobile device and for causing the alert information to be played when the mobile device and the telematics unit are within range over the first communications interface. In a third aspect, the invention includes a method of providing alert information to a user of a vehicle, from a mobile device, the method comprising pairing the mobile device with a telematics unit associated with the vehicle, and then separating the mobile device and the telematics device such that they are no longer in communication. While the mobile device and the telematics unit are separated, the mobile device receives alert information over a satellite interface and stores the alert information in a memory of the mobile unit. The mobile device later detects that the mobile device and the telematics unit are within range of one another and causes the alert information to be played.

### BRIEF DESCRIPTION OF THE SEVERAL VIEWS OF THE DRAWINGS

FIG. 1 is a schematic view of an example communication system within which the present invention optionally may be implemented;

FIG. 2 is schematic view of an example network arrangement within which an example implementation may be carried out;

FIG. 3 is schematic diagram of a mobile device and associated components in accordance with an example of the invention; and

FIG. 4 is a flow diagram illustrating a process of providing alert information to a user of a vehicle in accordance with an exemplary implementation.

### DETAILED DESCRIPTION OF THE INVENTION

Before describing the invention in detail, an exemplary environment in which the invention may operate will be described. It will be appreciated that the described environment is for purposes of illustration only, and does not imply any limitation regarding the use of other environments to practice the invention.

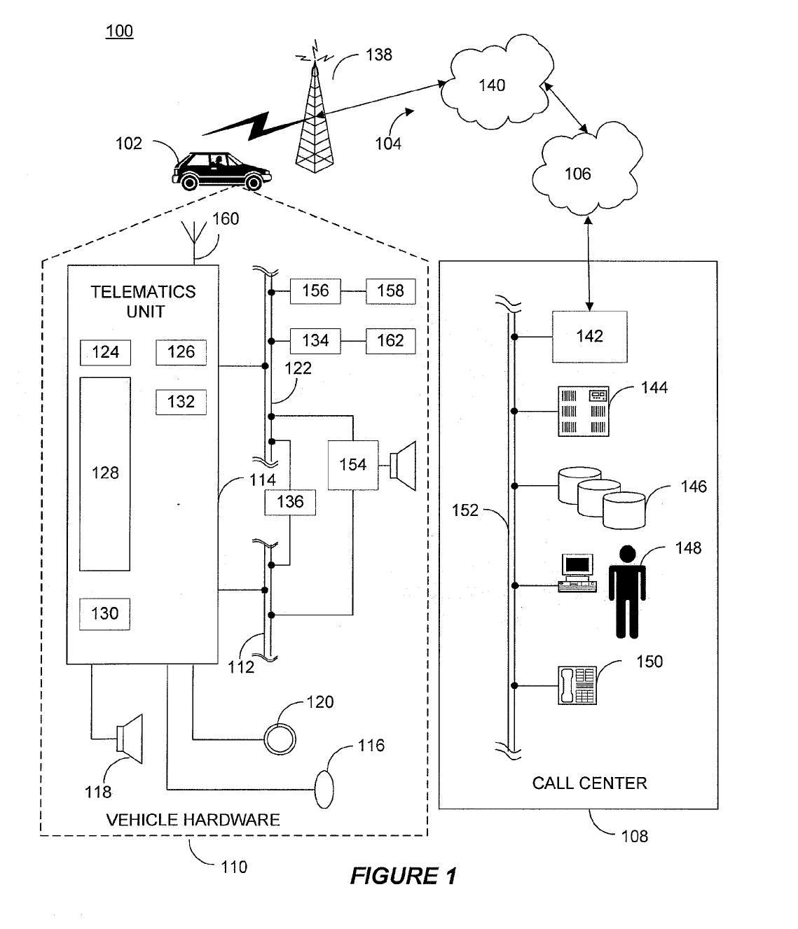

With reference to FIG. 1 there is shown an example of a communication system 100 that may be used with the present method and generally includes a vehicle 102, a wireless carrier system 104, a land network 106 and a call center 108. It should be appreciated that the overall architecture, setup and operation, as well as the individual components of a system such as that shown here are generally known in the art. Thus, the following paragraphs simply provide a brief overview of one such exemplary information system 100; however, other systems not shown here could employ the present method as well.

Vehicle 102 is preferably a mobile vehicle such as a motorcycle, car, truck, recreational vehicle (RV), boat, plane, etc., and is equipped with suitable hardware and software that enables it to communicate over system 100. Some of the vehicle hardware 110 is shown generally in FIG. 1 including a telematics unit 114, a microphone 116, a speaker 118 and buttons and/or controls 120 connected to the telematics unit 114. Operatively coupled to the telematics unit 114 is a network connection or vehicle bus 122. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few.

The telematics unit 114 is an onboard device that provides a variety of services through its communication with the call center 108, and generally includes an electronic processing device 128 one or more types of electronic memory 130, a cellular chipset/component 124, a wireless modem 126, a dual antenna 160 and a navigation unit containing a GPS chipset/component 132. In one example, the wireless modem 126 is comprised of a computer program and/or set of software routines executing within processing device 128.

The telematics unit 114 provides too many services to list them all, but several examples include: turn-by-turn directions and other navigation-related services provided in conjunction with the GPS based chipset/component 132; airbag deployment notification and other emergency or roadside assistance-related services provided in connection with various accident and or collision sensor interface modules 156 and sensors 158 located throughout the vehicle. Infotainment-related services where music, Web pages, movies, television programs, video games and/or other content is downloaded by an infotainment center 136

operatively connected to the telematics unit 114 via vehicle bus 122 and audio bus 112. In one example, downloaded content is stored for current or later playback.

Again, the above-listed services are by no means an exhaustive list of all the capabilities of telematics unit 114, as should be appreciated by those skilled in the art, but are simply an illustration of some of the services that the telematics unit is capable of offering. It is anticipated that telematics unit 114 include a number of known components in addition to those listed above.

Vehicle communications preferably use radio transmissions to establish a voice channel with wireless carrier system 104 so that both voice and data transmissions can be sent and received over the voice channel. Vehicle communications are enabled via the cellular chipset/component 124 for voice communications and a wireless modem 126 for data transmission. In order to enable successful data transmission over the voice channel, wireless modem 126 applies some type of encoding or modulation to convert the digital data so that it can communicate through a vocoder or speech codec incorporated in the cellular chipset/component 124. Any suitable encoding or modulation technique that provides an acceptable data rate and bit error can be used with the present method. Dual mode antenna 160 services the GPS chipset/component and the cellular chipset/component.

Microphone 116 provides the driver or other vehicle occupant with a means for inputting verbal or other auditory commands, and can be equipped with an embedded voice processing unit utilizing a human/machine interface (HMI) technology known in the art. Conversely, speaker 118 provides verbal output to the vehicle occupants and can be either a stand-alone speaker specifically dedicated for use with the telematics unit 114 or can be part of a vehicle audio component 154. In either event, microphone 116 and speaker 118 enable vehicle hardware 110 and call center 108 to communicate with the occupants through audible speech. The vehicle hardware also includes one or more buttons or controls 120 for enabling a vehicle occupant to activate or engage one or more of the vehicle hardware components 110. For example, one of the buttons 120 can be an electronic push button used to initiate voice communication with call center 108 (whether it be a live advisor 148 or an automated call response system). In another example, one of the buttons 120 can be used to initiate emergency services.

The audio component 154 is operatively connected to the vehicle bus 122 and the audio bus 112. The audio component 154 receives analog information, rendering it as sound, via the audio bus 112. Digital information is received via the vehicle bus 122. The audio component 154 provides AM and FM radio, CD, DVD, and multimedia functionality independent of the infotainment center 136. Audio component 154 may contain a speaker system, or may utilize speaker 118 via arbitration on vehicle bus 122 and/or audio bus 112.

The vehicle accident and/or collision detection sensor interface 156 are operatively connected to the vehicle bus 122. The accident sensors 158 provide information to the telematics unit via the accident and/or collision detection sensor interface 156 regarding the severity of a vehicle collision, such as the angle of impact and the amount of force sustained.

Vehicle sensors 162, connected to various sensor interface modules 134 are operatively connected to the vehicle bus 122. Example vehicle sensors include but are not limited to gyroscopes, accelerometers, magnetometers, emission detection and/or control sensors, and the like. Example sensor interface modules 134 include power train control, climate control, and body control, to name but a few.

Wireless carrier system 104 is preferably a cellular telephone system or any other suitable wireless system that transmits signals between the vehicle hardware 110 and land network 106. According to an example, wireless carrier system 104 includes one or more cell towers 138, base stations and/or mobile switching centers (MSCs) 140, as well as any other networking components required to connect the wireless system 104 with land network 106. A component in the mobile switching center may include a remote data server 180. As appreciated by those skilled in the art, various cell tower/base station/MSC arrangements are possible and could be used with wireless system 104. For example, a base station and a cell tower could be co-located at the same site or they could be remotely located, and a single base station could be coupled to various cell towers or various base stations could be coupled with a single MSC, to but a few of the possible arrangements. Preferably, a speech codec or vocoder is incorporated in one or more of the base stations, but depending on the particular architecture of the wireless network, it could be incorporated within a Mobile Switching Center or some other network components as well.

Land network 106 can be a conventional land-based telecommunications network that is connected to one or more landline telephones and connects wireless carrier network 104 to call center 108. For example, land network 106 can include a public switched telephone network (PSTN) and/or an Internet protocol (IP) network, as is appreciated by those skilled in the art. Of course, one or more segments of the land network 106 can be implemented in the form of a standard wired network, a fiber or other optical network, a cable network, other wireless networks such as wireless local networks (WLANs) or networks providing broadband wireless access (BWA), or any combination thereof.

Call Center (OCC) 108 is designed to provide the vehicle hardware 110 with a number of different system back-end functions and, according to the example shown here, generally includes one or more switches 142, servers 144, databases 146, live advisors 148, as well as a variety of other telecommunication and computer equipment 150 that is known to those skilled in the art. These various call center components are preferably coupled to one another via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modem or other piece of equipment 150 for demodulation and further signal processing. The modem 150 preferably includes an encoder, as previously explained, and can be connected to various devices such as a server 144 and database 146. For example, database 146 could be designed to store subscriber profile records, subscriber behavioral patterns, or any other pertinent subscriber information. Although the illustrated example has been described as it would be used in conjunction with a manned call center 108, it will be appreciated that the call center 108 can be any central or remote facility, manned or unmanned, mobile or fixed, to or from which it is desirable to exchange voice and data.

As part of its function, the telematics unit 114 can provide alerts to the user of the vehicle 102. Typically, such alerts may occur while the vehicle 102 and the telematics unit 114 are in an off state. Thus, the telematics unit 114 may supply alerts to the user upon the occurrence of an ignition event wherein the user turns the vehicle on, thus powering up the telematics unit 114 as well.

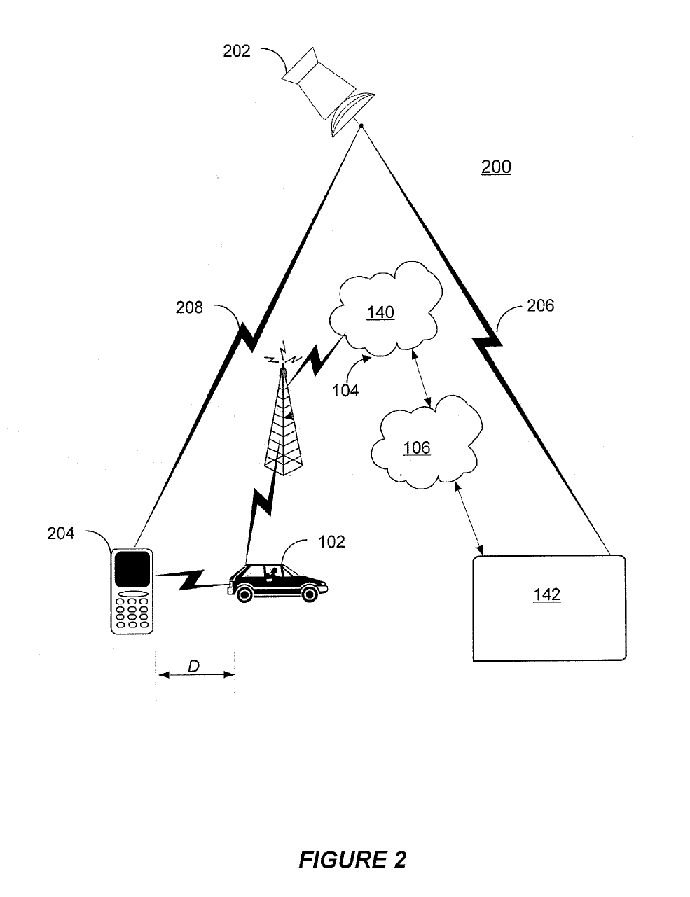

FIG. 2 is a schematic view of an exemplary system architecture in keeping with the disclosed principles. In particular, FIG. 2 illustrates a network environment including among other elements, the networks elements used to implement the disclosed system of alert provision. The illustrated environment 200 comprises the vehicle 102, as well the communications channel described in FIG. 1, including the mobile switching center 140 and call center 108, wireless carrier system 104, and land network 106. These elements allow the call center 108 to communicate with the telematics unit 114 via a wireless cellular channel, such as to send and receive information from the telematics unit 114. However, this mode of communication can be expensive.

Thus, FIG. 2 also shows an additional channel of communication that may be used in accordance with the disclosed principles to deliver alerts to the vehicle 102 (i.e., to its telematics unit 114) in an expedient and cost-effective manner. The additional channel comprises an uplink 206 from the call center 142 to a satellite 202. It will be appreciated that the uplink 206 may include a number of links including terrestrial and airborne or space borne entities such as a ground station, relay station, etc., but the uplink 206 is shown as a single link for purposes of clarity and brevity.

The additional communications channel also includes a broadcast link from the satellite 202 to a mobile device 204, whereby the mobile device 204 may receive broadcast information from the satellite 202. Satellite broadcasts from the satellite 202 may be device-specific or may be nonaddressed, and the use of both and either is contemplated. Moreover, it will be appreciated that in most implementations, the satellite 202 will not be dedicated to the system 200 but will also serve other information transfer needs to the telematics unit 102, a satellite receiver, or other devices not shown.

Finally, the mobile device 204 is associated with the telematics unit 114 of the vehicle 102. The association between the telematics unit 114 and the mobile device 204 is a logical association, although the mobile device 204 and the telematics unit 114 will not always be in communication. When in communication, the mobile device 204 and the telematics unit 114 may communicate via any short range or other wireless technology such as near-field communications link, BLUETOOTH, 802.11x and other protocols and link types.

In overview, the call center 142 receives or generates alert information appropriate for the driver of the vehicle 102 based on the vehicle's type, location, driver identity, or other criteria. The call center 142 then uploads the alert information directly or indirectly to the satellite 202 for transmission from the satellite 202 to the mobile device 204. At this time, the mobile device stores the received alert information as it may or may not be physically close to and in communication with the telematics unit 114 of the vehicle 102.

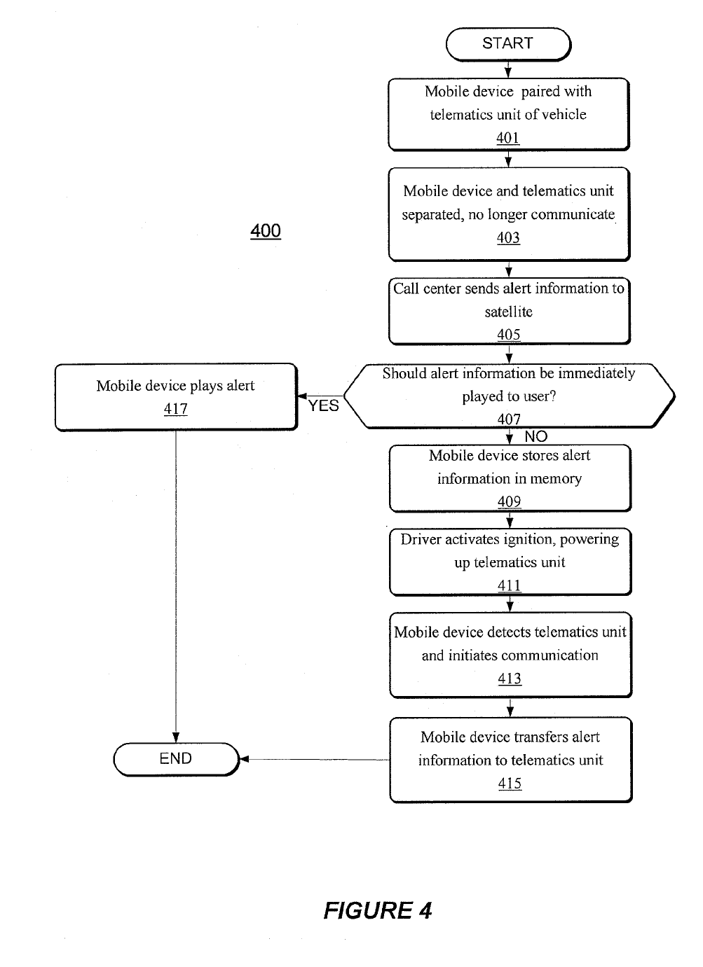

When the mobile device 204 and the telematics unit 114 are within communication range of each other via their wireless channel, e.g., BLUETOOTH, the mobile device 204 initiates a transfer of the alert information from the mobile device 204 to the telematics unit 114 for display or playing to the user. Optionally, the transfer is initiated upon an ignition event in the vehicle 102. The alert process will be discussed in greater detail below with reference to FIG. 4.

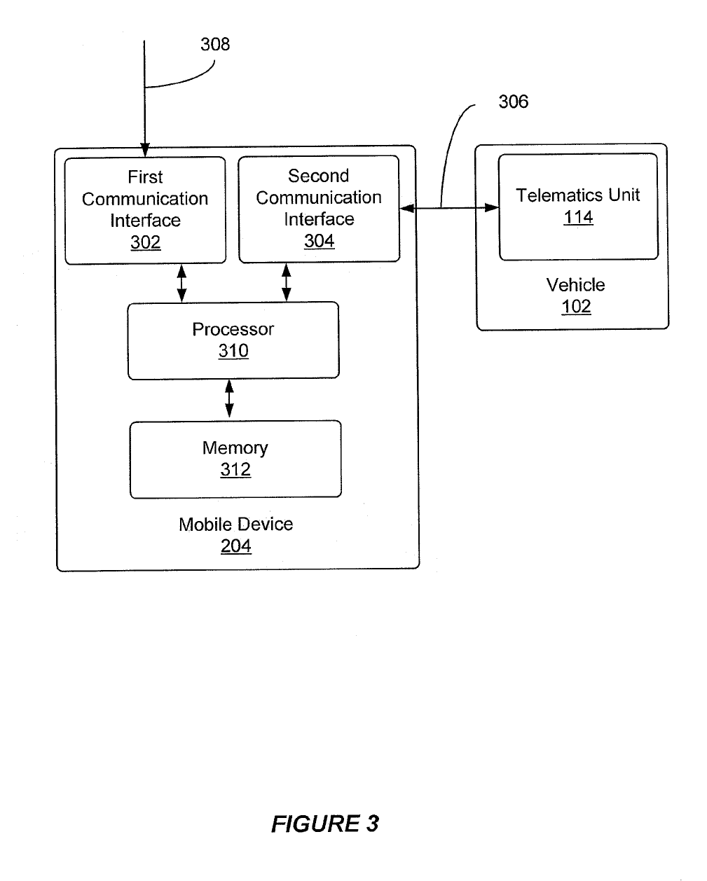

Before proceeding to an in-depth discussion of the alert process, an overview of an example device architecture will be given with reference to FIG. 3. As shown in FIG. 3, the mobile device 204 comprises a first communication interface 302 for receiving satellite broadcast transmissions such as from an XM or other satellite subscriber service or a non-subscriber service over a first link 308. It will be appreciated that the first communication interface 302 is capable of receiving radio frequency transmissions in a certain frequency range regardless of their source. The first communication interface 302 will typically, though not necessarily, be a unidirectional interface.

As can be seen, the mobile device 204 also includes a second communication interface 304 for sending and receiving information over a short range link 306 such as a BLUETOOTH, near field, 802.11x or other link to the telematics unit 114 which is associated with the vehicle 102 for purposes of power and location. The mobile device 204 also comprises a processor 310 for coordinating communications on both interfaces 302, 304 and for causing transmissions from the second interface 304. In addition, in the illustrated configuration, the mobile device 204 contains a memory 312 for storing data received on the first communication interface 302 prior to transmission via the second communication interface 304.

It will be appreciated that the mobile device 204 may receive and process multiple channels over the first communication interface 302. For example, a user may be listening to a program broadcast over a first satellite channel while alert information is simultaneously being received at the same interface 302.

FIG. 4 is a flow diagram illustrating an example alert process in greater detail in accordance with an aspect of the invention. The figure assumes a network configuration as shown in FIG. 2 for the sake of clarity. However it will be appreciated that other similar configurations may be used without departing from the scope of the invention.

At a first stage 401 of the process 400, the mobile device 204 is paired with the telematics unit 114 of the vehicle 102. Those of skill in the art will appreciate the ways in which devices may be paired so as to communicate with one another over BLUETOOTH or other short range link. At a second stage 403 of the process 400, the mobile device 204 and the telematics device 114 are separated such that they no longer communicate. This may occur for example when the driver parks the vehicle 102 and, carrying the mobile device 204, walks away to shop, work, hike, attend a movie, etc.

While the mobile device 204 and telematics unit 114 are apart, the call center 142 or other entity sends alert information directly or indirectly to the satellite 202 for retransmission to the mobile device 204 at stage 405 of the process 400. Upon receipt of the alert information, the mobile device determines at stage 407 whether the alert information should be immediately played to the user, as with a crisis alert, or should be stored for future play, as with a traffic alert. If at stage 407 it is determined to store the information for later play, the mobile device 204 stores the alert information at stage 409 in the memory 312 for later transmission to the telematics unit 114.

When the driver returns to the vehicle 102, still carrying the mobile device 204, the alert information resides on the mobile device 204 but not yet on the telematics unit 114. At stage 411, the driver activates the ignition of the vehicle 102, powering up the telematics unit 114. Subsequently, the mobile device 204 detects the telematics unit 114 and initiates communication therewith at stage 413. Optionally, the mobile device 204 may play the alert information upon detection of the telematics unit 114 instead of transferring it. At stage 415, the mobile device 204 transfers the alert information to the telematics unit for play to the user. If at stage 407 it was instead determined to play the alert immediately to the user, then the mobile device plays the alert at stage 417 without traversing stages 409-415.

It will be appreciated that the process 400 is executed by an application residing on the mobile device 204. The application is a set of computer-executable instructions on a human tangible computer-readable memory such as a RAM, ROM, PROM, magnetic or optical memory unit, flash drive, disc drive, etc., excluding human intangible media such as electrical, electromagnetic, or acoustic waves or signals.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A system for providing alert information to a user of a vehicle, the system comprising:
a telematics unit associated with the vehicle and having audio and visual play functionalities, and further including a short range wireless interface;
a mobile wireless device that is paired with the vehicle via a pairing with the telematics unit, the mobile device further comprising:
a first communication interface for wirelessly receiving the alert information;
a second communication interface for communicating with the telematics unit via the short range wireless interface thereof;
a memory for storing the received alert information;
a processor for controlling the mobile device and for running an application for detecting that the mobile device is within range of the telematics unit via the second communications interface and for causing the alert information to be played in response to detecting that the mobile device is within range of the telematics unit.

2. The system for providing alert information to a user of a vehicle according to claim 1, wherein causing the alert information to be played comprises playing the alert information at the mobile device.

3. The system for providing alert information to a user of a vehicle according to claim 1, wherein causing the alert information to be played comprises transferring the alert information to the telematics unit which plays the alert information.

4. The system for providing alert information to a user of a vehicle according to claim 1, wherein causing the alert information to be played in response to detecting that the mobile device is within range of the telematics unit further comprises awaiting a vehicle ignition event before causing the alert information to be played.

5. The system for providing alert information to a user of a vehicle according to claim 1, wherein the short range wireless interface conforms to a wireless standard that is one of Bluetooth, near field, and 802.11x.

6. The system for providing alert information to a user of a vehicle according to claim 1, wherein the first communication interface is a satellite interface.

7. A computer-readable medium having thereon computer-executable instructions for providing alert information to a user of a vehicle, the computer-executable instructions comprising:
instructions for pairing a mobile device to a telematics unit associated with the vehicle, the pairing being over a first communication interface of the mobile device;
instructions for receiving alert information over a second communication interface of the mobile device; and
instructions for causing the alert information to be played when the mobile device and the telematics unit are within range over the first communications interface.

8. The computer-readable medium according to claim 7, wherein the instructions for causing the alert information to be played when the mobile device and the telematics unit are within range comprise instructions for playing the alert information at the mobile device.

9. The computer-readable medium according to claim 7, wherein the instructions for causing the alert information to be played when the mobile device and the telematics unit are within range comprise instructions for transferring the alert information to the telematics unit which plays the alert information.

10. The computer-readable medium according to claim 7, wherein the instructions for causing the alert information to be played when the mobile device and the telematics unit are within range further comprise instructions for awaiting a vehicle ignition event before causing the alert information to be played.

11. The computer-readable medium according to claim 7, wherein the first communication interface conforms to a wireless standard that is one of Bluetooth, near field, and 802.11x.

12. The computer-readable medium according to claim 7, wherein the second communication interface is a satellite interface.

13. A method of providing alert information to a user of a vehicle, from a mobile device, the method comprising:
over a first communication channel, pairing the mobile device with a telematics unit associated with the vehicle;
separating the mobile device and the telematics device such that they are no longer in communication;
while the mobile device and the telematics unit are separated, receiving alert information at the mobile device over a second communication interface;
determining whether the alert information should be immediately played to the user, and if it is determined that the alert information should not be immediately played to the user, storing the alert information in a memory of the mobile unit;
detecting that the mobile device and the telematics unit are within range of one another over the first communication channel and in response to this determination causing the alert information to be played.

14. The method for providing alert information to a user of a vehicle according to claim 11, wherein causing the alert information to be played comprises playing the alert information at the mobile device.

15. The method for providing alert information to a user of a vehicle according to claim 13, wherein causing the alert information to be played comprises transferring the alert information to the telematics unit which plays the alert information.

16. The method for providing alert information to a user of a vehicle according to claim 13, wherein causing the alert information to be played further comprises awaiting a vehicle ignition event before causing the alert information to be played.

17. The method for providing alert information to a user of a vehicle according to claim 13, wherein the first communication interface conforms to a wireless standard that is one of Bluetooth, near field, and 802.11x.

18. The method for providing alert information to a user of a vehicle according to claim 13, further comprising playing the alert information to the user when it is received at the mobile device if it is determined that the alert information should be immediately played to the user.

19. The method for providing alert information to a user of a vehicle according to claim 13, wherein receiving alert information at the mobile device over a second communication interface comprises receiving the alert information at the mobile device over a satellite receiver channel.
